(19) United States
(12) Patent Application Publication
(10) Pub. No.: US 2024/0208435 A1
(43) Pub. Date: Jun. 27, 2024

(54) VANITY FRAME FOR FRAMING LOGOS ON A VEHICLE

(71) Applicant: Jacques Caron, Boucherville (CA)

(72) Inventor: Jacques Caron, Boucherville (CA)

(21) Appl. No.: 18/395,014

(22) Filed: Dec. 22, 2023

(30) Foreign Application Priority Data
Dec. 23, 2022 (GB) 2219741.2

(51) Int. Cl. B60R 13/10

(52) U.S. Cl. CPC B60R 13/105

(57) ABSTRACT

This invention provides a vanity frame for a vehicle's license plate, featuring a rectangular design compatible with standard license plate dimensions. The frame includes two longer and two shorter sides, with a central opening for license plate visibility. A distinctive feature of this frame is the inclusion of pass-through openings on its sides and a cavity in one of the longer sides. This cavity accommodates a plate displaying high relief shapes, such as alphanumeric symbols, which protrude prominently from the plate. Some embodiments allow for the adaptation of the shorter sides to receive shapes or logos. Additionally, the frame may have tabs with threaded holes for attaching the logos or decorative elements securely. Available in various colors, the frame and high relief shapes offer customization options to enhance vehicle aesthetics while maintaining standard license plate visibility.

### CROSS-REFERENCE TO RELATED APPLICATIONS

The present application claims priority to UK request GB2219741.2, filed on Dec. 23, 2022 which is hereby incorporated in its entirety at least by reference.

### BACKGROUND OF THE INVENTION

### 1. Field of the Invention

The present invention relates generally to car accessories but more particularly to a vanity frame for framing logos on a vehicle.

### 2. Description of Related Art

The use of vanity license plates and branded frames has been a long-standing practice in the automotive industry. While these frames serve branding purposes, they often fail to complement the aesthetic appeal of luxury vehicles, particularly due to their material and design limitations. Additionally, the vast array of color combinations required to match various vehicle designs poses a significant inventory challenge for sellers. Existing solutions, predominantly made of plastic or metal, do not adequately address these concerns, often leading to a compromise between branding effectiveness and aesthetic harmony. Furthermore, the placement of these frames and their integration with other vehicle branding elements, such as model logos, has not been optimally explored. This background underscores the need for an innovative approach that harmonizes branding with the luxury and design elements of high-end vehicles, while also addressing the logistical challenges posed by inventory management.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present invention to provide for a vanity frame for framing logos on a vehicle with improved aesthetic appeal.

In order to do so, a vanity frame for a license plate is provided, comprising a rectangular frame configured to enclose a license plate; the frame having two longer sides and two shorter sides; a central opening in the frame to display the license plate; at least one pass-through opening on one of the sides of the frame; a cavity within at least one of the longer sides of the frame; and a plate insertable into the cavity, wherein the plate is configured to display high relief shapes.

In one embodiment, the high relief shapes represent alphanumeric symbols. In one embodiment, at least one of the shorter sides is configured to be as wide as the longer sides to receive a shape. In one embodiment, the shape is a logo. In another embodiment, at least one tab with a threaded hole for the attachment of the logo via a mechanical fastener is provided. In one embodiment, the frame and the high relief shapes are available in various colors. In one embodiment, the frame allows for customizable color combinations of the frame and the high relief shapes

The foregoing has outlined rather broadly the more pertinent and important features of the present invention so that the detailed description of the invention that follows may be better understood and so that the present contribution to the art can be more fully appreciated. Additional features of the invention, which will be described hereinafter, form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF THE DRAWINGS

Other features and advantages of the present invention will become apparent when the following detailed description is read in conjunction with the accompanying drawings, in which:

FIG. 1 is an exploded view of the vanity frame according to an embodiment of the present invention.

FIG. 2 is an isometric rear view of the vanity frame according to an embodiment of the present invention.

FIG. 3 is an isometric view of the vanity frame installed on a license plate according to an embodiment of the present invention.

FIG. 4A is a front view of the vanity frame installed on a vehicle according to an embodiment of the present invention.

FIG. 4B is a front view of the vanity frame according to an embodiment of the present invention.

FIG. 5A is a front view of an alternative vanity frame having a logo attached to an end section according to an embodiment of the invention.

FIG. 5B is a front view of an alternative vanity frame having a logo attached to a tab section according to an embodiment of the invention.

FIG. 6A is an isometric view of an alternate vanity frame, showing a tab used in attaching a logo according to an embodiment of the invention.

FIG. 6B is an isometric view of an alternate vanity frame, showing the logo attached to the tab according to an embodiment of the invention.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a vanity frame for framing logos on a vehicle.

It is to be understood that the terminology used herein is for the purpose of describing particular embodiments only and is not intended to be limiting. The terms “a” or “an,” as used herein, are defined to mean “at least one.” The term “plurality,” as used herein, is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. These terms generally refer to a range of numbers that one of skill in the art would consider equivalent to the recited values (i.e., having the same function or result). In many instances these terms may include numbers that are rounded to the nearest significant figure.

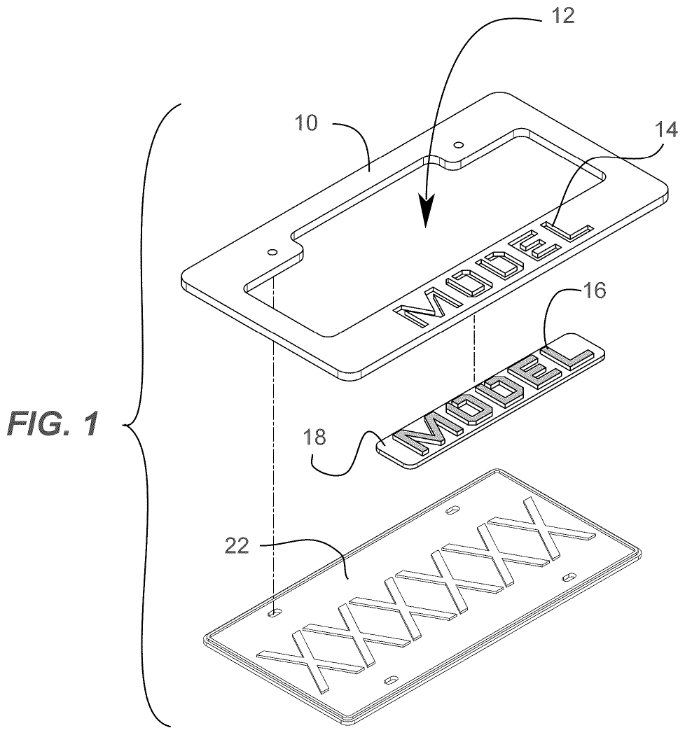

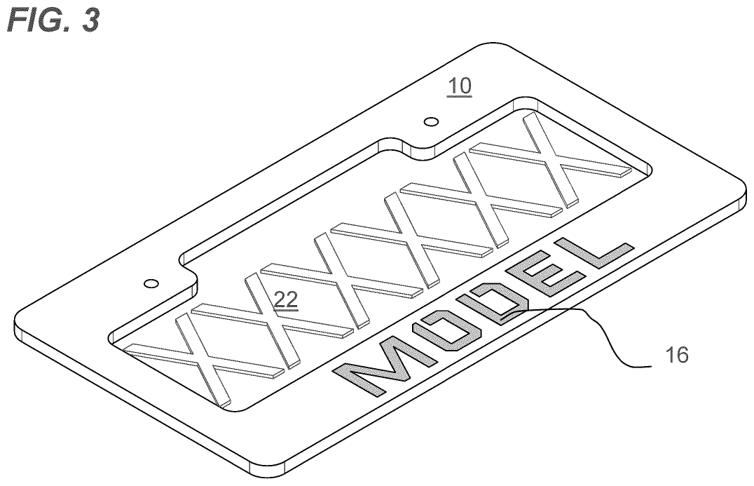

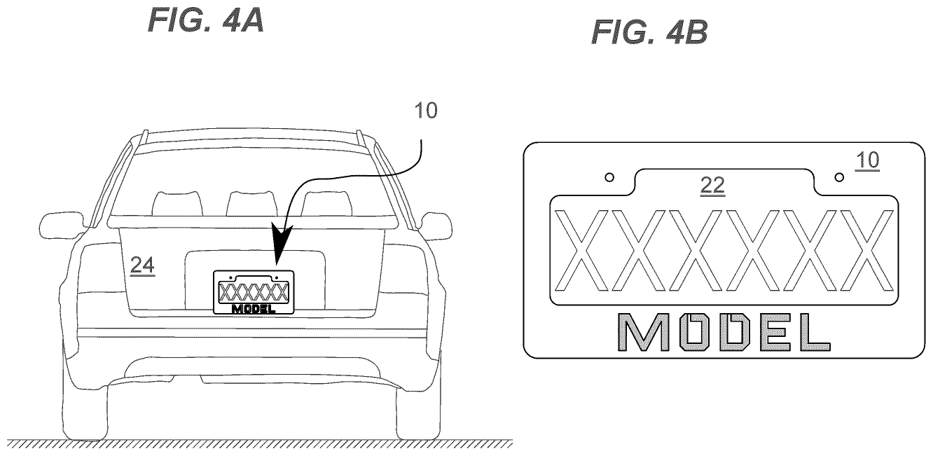

Referring to any of the accompanying figures FIG. 1-6B, in one embodiment, the present invention comprises a vanity frame 10 for a license plate 22 on a vehicle 24. In some embodiments, the frame 10 is rectangular, aligning with the standard shape of license plates 22, and includes two longer sides 11 and two shorter sides 13. As typically provided on license frames, a central opening 12 is incorporated to ensure the visibility of the license plate 22 when mounted, such that the license plate numbers/letters are visible to other drivers, police, cameras, as well known in the art. Advantageously, the frame 10 comprises pass-through openings 14 on at least one of its sides 11, 13. In a preferred embodiment, at least one of the long sides 11 is configured and sized to receive high relief shapes 16 by being wider than the other sides. These shapes 16, typically representing alphanumeric symbols, extrude in high relief fashion from a plate 18. The plate 18 itself is designed to frictionally insert into a cavity 20 in the frame 10, allowing the plate 18 to sit flush with the back of the frame 10, and the shapes 16 flush with the front, or even extrude so as to create a high relief look.

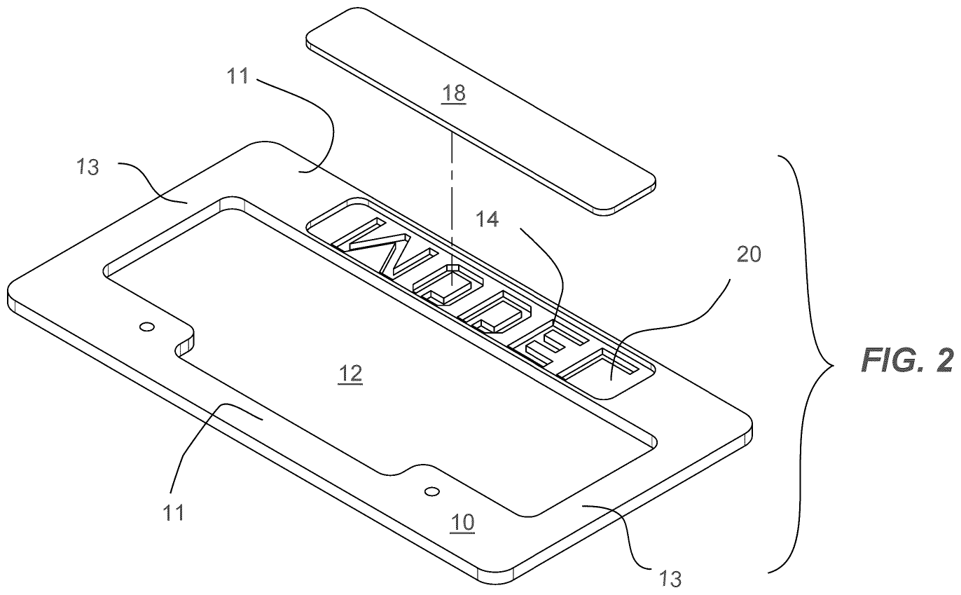

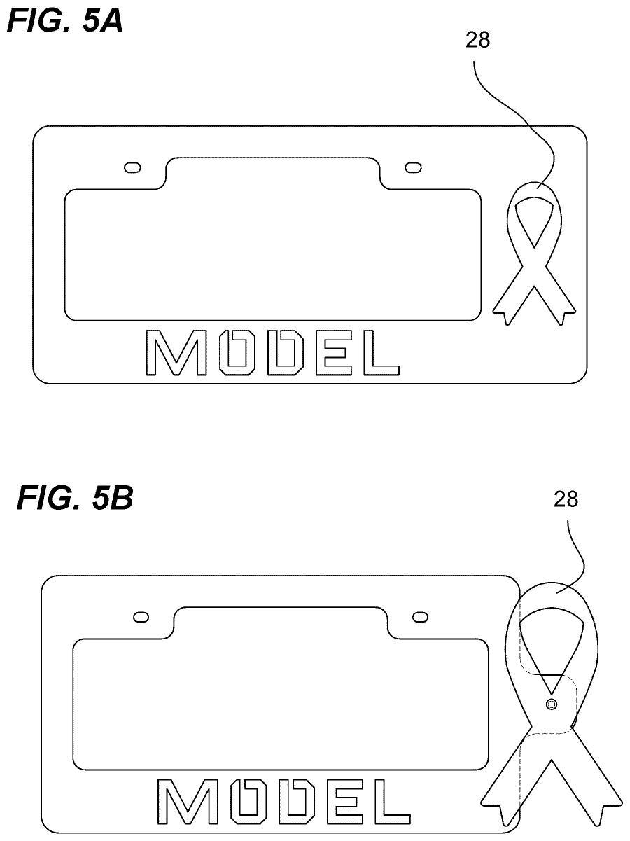

In an alternate embodiment, as illustrated in FIG. 5A, at least one of the short sides 13 is as wide as the long side 11 seen in FIG. 2, enabling it to receive a shape 16. This shape could be a logo 28, representing, for example, an association or a charity that the car owner supports. The installation mechanism for this embodiment mirrors the one previously described.

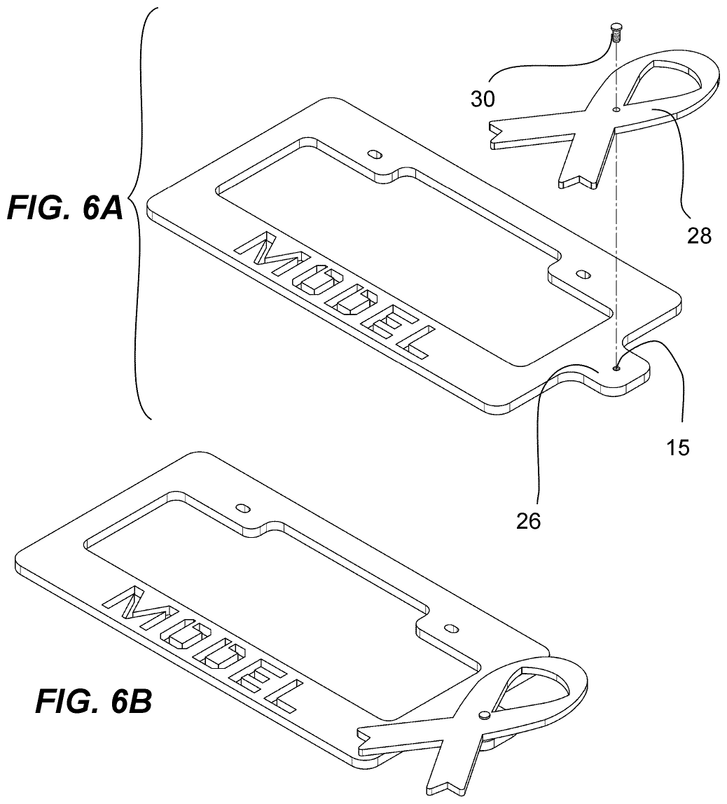

In yet another embodiment, best seen in FIGS. 5B and 6A-B, instead of wider short sides 13, the frame 10 includes at least one tab 26 with a threaded hole 15. This design allows for the secure attachment of a mechanical fastener 30 to affix a logo 28 to the side of the frame 10.

Advantageously, the vanity frame 10 and the shapes 16 are available in various colors. Ideally, users will select complementary colors for the frame 10 and shapes 16 to ensure high contrast and visibility of the shapes 16. Since some logos may have proprietary colors, it is advisable for buyers to consider this when making a purchase.

When installed on a vehicle 24, the plate 18 is positioned against the vehicle 24, ensuring it remains securely engaged with the frame 10. The logo 28 is installed via mechanical fastener 30 into threaded hole 15. By separating the shapes 16 from the frame 10, sellers can offer a limited inventory while still providing a wide range of customizable color combinations for the shapes 16 and frame 10.

For the purposes of this invention, “high relief” refers to a design element where the shapes 16, typically representing alphanumeric symbols or other decorative or informative designs, protrude significantly from the base surface or plate 18. This protrusion is characterized by a substantial depth, creating a pronounced three-dimensional effect that enhances visibility and tactile quality. The “high relief” design ensures that the shapes 16 are not only visually prominent but also physically discernible from the plate 18. This design choice contrasts with “low relief” (or bas-relief) where the depth of the protrusion is shallow, and the design is less pronounced from the background. In the context of the vanity frame 10, the high relief shapes 16 are designed to stand out prominently, providing an aesthetic appeal and ease of identification, which is particularly advantageous for branding or personalization purposes.

Although the invention has been described in considerable detail in language specific to structural features, it is to be understood that the invention defined in the appended claims is not necessarily limited to the specific features described. Rather, the specific features are disclosed as exemplary forms of implementing the claimed invention.

The terminology and phraseology used in this description and the abstract are for illustrative purposes and should not be considered as limiting. In other words, the terminology and phraseology used in this description and the abstract are for illustrative purposes and should not be considered limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention.

It should further be noted that throughout the entire disclosure, the labels such as left, right, front, back, top, bottom, forward, reverse, clockwise, counterclockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, references to “first,” “second,” “third,” and so fourth members throughout the disclosure (and in particular, claims) are not used to show a serial or numerical limitation but instead are used to distinguish or identify the various members of the group.

What is claimed is:

1. A vanity frame for a license plate, comprising:
a rectangular frame configured to enclose a license plate;
the frame having two longer sides and two shorter sides;
a central opening in the frame to display the license plate;
at least one pass-through opening on one of the sides of the frame;
a cavity within at least one of the longer sides of the frame; and
a plate insertable into the cavity, wherein the plate is configured to display high relief shapes.

2. The vanity frame of claim 1, wherein the high relief shapes represent alphanumeric symbols.

3. The vanity frame of claim 1, wherein at least one of the shorter sides is configured to be as wide as the longer sides to receive a shape.

4. The vanity frame of claim 3, wherein the shape is a logo.

5. The vanity frame of claim 4, further comprising at least one tab with a threaded hole for the attachment of the logo via a mechanical fastener.

6. The vanity frame of claim 1, wherein the frame and the high relief shapes are available in various colors.

7. The vanity frame of claim 1, wherein the frame allows for customizable color combinations of the frame and the high relief shapes.
